(19) United States
(12) Patent Application Publication
(10) Pub. No.: US 2009/0058878 A1
(43) Pub. Date: Mar. 5, 2009

(54) METHOD FOR DISPLAYING ADJUSTMENT IMAGES IN MULTI-VIEW IMAGING SYSTEM, AND MULTI-VIEW IMAGING SYSTEM

(75) Inventor: Mikio SASAGAWA, Kurokawa-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/201,419

(22) Filed: Aug. 29, 2008

(30) Foreign Application Priority Data
Aug. 31, 2007 (JP) 2007/225912

(51) Int. Cl. G09G 5/02; G09G 5/00

(52) U.S. Cl. 345/593; 345/632

(57) ABSTRACT

A multi-view imaging system which allows efficient and accurate adjustment of optical axes, and the like, of imaging units is disclosed. More than one images acquired with more than one cameras by imaging a subject are subjected to live view image processing to generate more than one live view images. The generated live view images are displayed in a superimposed manner on a display unit, and a vertical guideline extending in a vertical direction of the display unit and a horizontal guideline extending in a horizontal direction of the display unit are displayed on the display unit.

### BACKGROUND OF THE INVENTION

1. Field of the Invention

The present invention relates to a method for displaying adjustment images for adjusting the optical axes of more than one cameras used for imaging the same subject in a multi-view imaging system, and to the multi-view imaging system.

2. Description of the Related Art

Multi-view imaging systems having more than one imaging units and being able to carry out 3D (three-dimensional) imaging or panoramic imaging, for example, have been proposed. In such a multi-view imaging system, the more than one imaging units are arranged side by side, and images simultaneously acquired by the imaging units are combined to generate a stereoscopic image which can be viewed stereoscopically or a panoramic image.

In the multi-view imaging system, it is necessary to adjust the optical axis, imaging magnification, and the like, of each imaging unit before imaging to correct misalignment of images acquired by the imaging units. Therefore, the multi-view imaging system having the more than one imaging units is provided with a mechanism for moving the optical axis of each imaging unit in the horizontal and vertical directions and rotating or tilting the imaging unit and a zooming mechanism (a driving mechanism). Then, a chart containing a cross shape is simultaneously shot by the more than one imaging units, and an amount of misalignment of the cross shape in each of the thus acquired images is measured. Then, the driving mechanism for the imaging units is driven to eliminate the misalignment, thereby achieving adjustment of the optical axes, and the like, of the imaging units.

As a method for adjusting the angle of view without using a chart such as one described above, images acquired by the cameras are displayed on separate monitors one by one, and the angle of view of each camera is adjusted based on the position of the image displayed on each monitor. Further, it is possible to apply live view image processing to the images acquired by the cameras, and thus generated live view images may be displayed in a superimposed manner to adjust the angles of view of the cameras. In methods proposed in Japanese Unexamined Patent Publication No. 2006-094030, and U.S. Patent Application Publication Nos. 20050052551, 20020008765 and 20030164890, when a composite image is generated with a single-view imaging apparatus, one of images to be combined is displayed as a live view image, and a composite image can be generated with simple operations.

However, in the case where the images acquired by the cameras are displayed on separate monitors to adjust the angles of view of the cameras, as described above, it is difficult to understand relative positions of the cameras, and the user may fail to accurately adjust the angles of view of the cameras.

Further, in the case where the live view images acquired by the cameras are combined using the technique for combining live view images disclosed in the above-mentioned Japanese Unexamined Patent Publication No. 2006-094030, and U.S. Patent Application Publication Nos. 20050052551, 20020008765 and 20030164890 to recognize amounts of positional misalignment, and the like, from the combined live view images before adjusting the angles of view of the cameras, it is necessary to repeat operations to combine the images and adjust the angle of view, and this is troublesome.

### SUMMARY OF THE INVENTION

In view of the above-described circumstances, the present invention is directed to providing a method for displaying adjustment images in a multi-view imaging system and the multi-view imaging system which allow efficient and accurate adjustment of optical axes, and the like, of the cameras.

The method for displaying adjustment images in a multi-view imaging system of the invention includes: imaging a subject with a plurality of cameras to acquire a plurality of images; generating a plurality of live view images by applying live view image processing to the acquired images; and displaying the generated live view images in a superimposed manner on a display unit and displaying, at arbitrary positions on the display unit, a vertical guideline extending in a vertical direction of the display unit and a horizontal guideline extending in a horizontal direction of the display unit.

The multi-view imaging system of the invention includes: a plurality of cameras to image a subject and acquire images; an image processing unit to apply live view image processing to the images acquired by the cameras to generate a plurality of live view images; and a display controlling unit to display the live view images generated by the image processing unit in a superimposed manner on a display unit and to display, at arbitrary positions on the display unit, a vertical guideline extending in a vertical direction of the display unit and a horizontal guideline extending in a horizontal direction of the display unit.

The number of the plurality of cameras may be any number, as long as there are two or more cameras.

The vertical guideline and the horizontal guideline may be displayed to extend across the screen of the display unit in the vertical and horizontal directions, or may be displayed to form a frame surrounding a predetermined region on the display unit.

The image processing unit may be provided in each camera, or a single image processing unit may apply the live view image processing to the images inputted from the cameras.

The display controlling unit may display the live view images which have been converted to have equal image transparency in the superimposed manner, or may display the live view images in different colors or different densities.

The display controlling unit may display camera information for identifying the individual cameras on the display unit, in addition to the live view images. The display controlling unit may display the camera information in different colors or different densities correspondingly to the live view images on the display unit.

The multi-view imaging system may further include: a subject detecting unit to detect the subject from each of the live view images; and a position determining unit to determine, for each of the live view images, whether or not the subject detected by the subject detecting unit is positioned in a predetermined area on the display unit. If the position determining unit has determined that any of the live view images contains the subject which is positioned out of the predetermined area, the display controlling unit may display the determined live view image in a recognizable manner. It should be noted that “display in a recognizable manner” means, for example, to display the misaligned live view image in a different color, in a different density or to blink the misaligned live view image so that it can readily be recognized.

The multi-view imaging system may further include: an area detecting unit to detect an imaging area contained in all the live view images; and a trimming unit to trim the live view images using the imaging area detected by the area detecting unit.

The display controlling unit may include a function to display thumbnails of the live view images, in addition to the function to display the generated live view images in the superimposed manner on the display unit and to display the vertical guideline extending in the vertical direction of the display unit and the horizontal guideline extending in the horizontal direction of the display unit.

### BRIEF DESCRIPTION OF THE DRAWINGS

FIG. 1 is a schematic diagram illustrating a preferred embodiment of a multi-view imaging system of the present invention,

FIG. 2 is a perspective view illustrating the appearance of a camera shown in FIG. 1,

FIG. 3 is a block diagram illustrating a preferred embodiment of the multi-view imaging system of the invention,

FIG. 4 is a schematic diagram illustrating how live view images are displayed on a display unit by a display controlling unit shown in FIG. 3,

FIG. 5 is a schematic diagram illustrating how live view images are displayed on the display unit by the display controlling unit shown in FIG. 3,

FIG. 6 is a schematic diagram illustrating how vertical guidelines and horizontal guidelines are displayed on the display unit by the display controlling unit shown in FIG. 3,

FIG. 7 is a flow chart illustrating a preferred embodiment of a method for displaying adjustment images in the multi-view imaging system of the invention,

FIG. 8 is a block diagram illustrating a second embodiment of the multi-view imaging system of the invention,

FIGS. 9A and 9B are schematic diagrams illustrating how the live view images are displayed on the display unit by the display controlling unit shown in FIG. 8,

FIG. 10 is a flow chart illustrating a preferred embodiment of a method for displaying adjustment images in the multi-view imaging system shown in FIG. 8,

FIG. 11 is a block diagram illustrating a third embodiment of the multi-view imaging system of the invention,

FIGS. 12A and 12B are schematic diagrams illustrating a trimming operation by a trimming unit in the multi-view imaging system shown in FIG. 11, and

FIG. 13 is a flow chart illustrating a preferred embodiment of a method for displaying adjustment images in the multi-view imaging system shown in FIG. 11.

### DESCRIPTION OF THE PREFERRED EMBODIMENTS

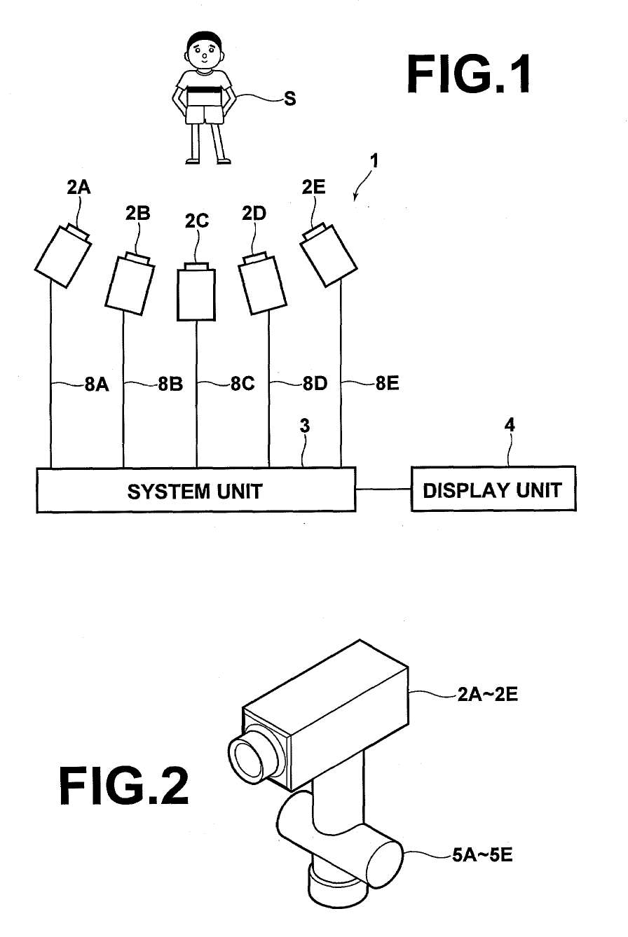

Hereinafter, embodiments of the multi-view imaging system according to the present invention will be described with reference to the drawings. FIG. 1 illustrates the schematic configuration of the multi-view imaging system of the invention. A multi-view imaging system 1 shown in FIG. 1 includes five cameras 2A-2E, a system unit 3 and a display unit 4. The cameras 2A-2E are connected to the system unit 3 via cables 8A-8E, such as USB cables.

The five cameras 2A-2E are arranged along an arc around a position where a subject is placed. As shown in FIG. 2, the cameras 2A-2E are respectively provided with optical axis adjustment units 5A-SE for adjusting imaging optical axes of the cameras in pan- and tilt-directions. The optical axis adjustment units 5A-5E are driven to rotate according to manual operations or instructions from the system unit 3 to adjust the imaging optical axes.

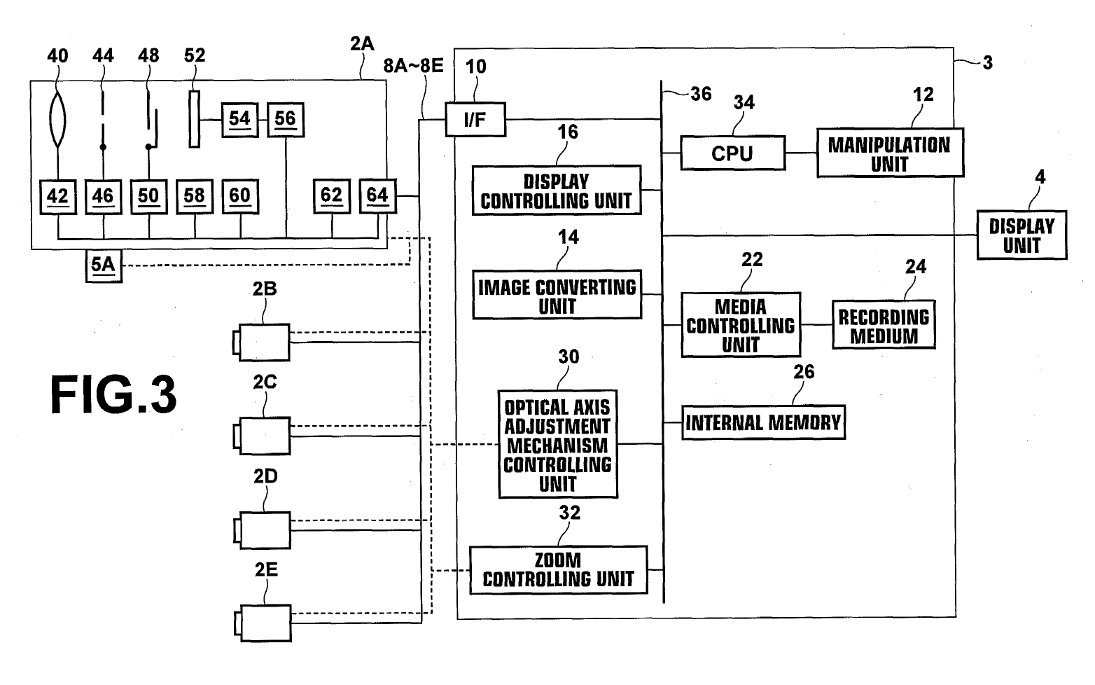

FIG. 3 is a block diagram illustrating the configuration of the multi-view imaging system of the invention. The multi-view imaging system 1 includes the cameras 2A-2E and the system unit 3. The five cameras 2A-2E shown in FIG. 3 have the same internal configuration, and therefore, only the internal configuration of the camera 2A is shown.

The system unit 3 exerts various controls in the multi-view imaging system 1 through a CPU 34 executing a program stored in an internal memory 26. The CPU 34 has a function to switch between a normal imaging mode for acquiring a 3D image, or the like, and an adjustment mode for adjusting the angles of view of the cameras 2A-2E, according to an input from the user via a manipulation unit 12 formed, for example, by a keyboard and a mouse.

In the adjustment mode, coordinate information and ID information of each of the cameras 2A-2E are acquired, and the cameras 2A-2F are controlled via an interface 10 to acquire live view images P1-P5 for adjustment of the optical axes of the cameras. On the other hand, in the normal imaging mode, the system unit 3 is controlled, for example, to display live view images acquired by the cameras 2A-2E on the display unit 4 and record the images on the recording medium 24.

The camera 2A images the subject S to acquire an image of the subject, and includes an imaging lens 40 formed by a focusing lens and a zooming lens, an aperture diaphragm 44, a shutter 48, an image pickup device 52, and the like. The focusing lens and the zooming lens of the imaging lens 40 are disposed to be movable along the optical axis by a lens driving mechanism 42, which is formed by a motor and a motor driver. The aperture diameter of the aperture diaphragm 44 is adjusted by an aperture diaphragm driving unit 46. The shutter 48 is a mechanical shutter, and is driven by a shutter driving unit 50 according to an instruction from the system unit 3.

The image pickup device 52 is formed, for example, by a CCD or CMOS, in which a large number of light receiving elements are arranged two-dimensionally. An image of the subject passing through the imaging lens 40, and the like, is focused on the image pickup device 52, and is subjected to photoelectric conversion at the image pickup device 52. Then, the image pickup device 52 outputs image information of the subject image containing R, G and B analog signals. The analog imaging signal outputted from the CCD 52 is inputted to an analog signal processing unit 54, and is subjected to noise reduction and gain adjustment (analog processing). The imaging signal subjected to the analog processing is converted into digital image data by an A/D converter 56. The camera 2A includes a memory 60 which stores the ID information for identifying the camera 2A and a program for driving the camera 2A.

An image processing unit 62 applies various processing and conversion to the image acquired at the image pickup device 52, and has a function to generate the live view image P1 by applying live view image processing to the image acquired by the image pickup device 52. Therefore, images acquired by the camera 2A includes an actually-photographed image which is acquired and recorded on the recording medium 24 according to an imaging instruction from the system unit 3, and the live view image P1 for checking a content to be photographed.

In the normal imaging mode, the image processing unit 62 applies image quality correction, such as tone correction, sharpness correction and color correction, to the image acquired by the camera 2A to obtain a processed image. On the other hand, in the adjustment mode, the image processing unit 62 generates the live view image P1 using the image information acquired by the image pickup device 52. The number of pixels of the live view image P1 is smaller than that of the actually-photographed image, and may be, for example, about 1/16 of the number of pixels forming the actually-photographed image. The live view images P1-P5 successively acquired by the cameras 2A-2E are inputted to the system unit 3 via an interface 64.

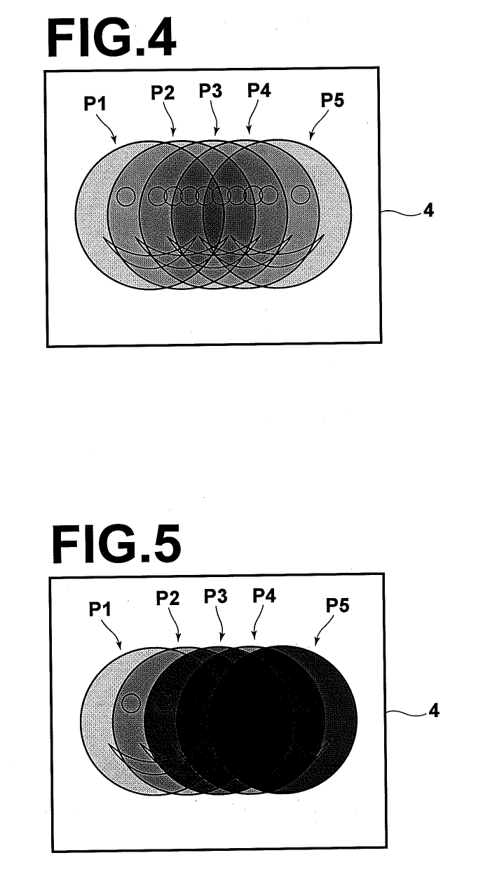

The system unit 3 includes an image converting unit 14 and a display controlling unit 16. The respective components are connected to each other via a data bus so that data can be transferred between them. In the adjustment mode, the image converting unit 14 converts the live view images P1-P5 for displaying the live view images P1-P5 transferred from the cameras 2A-2E in a superimposed manner, as shown in FIG. 4. Specifically, the image converting unit 14 detects the number of cameras 2A-2E connected to the system unit 3 from the number of live view images P1-P5 transmitted thereto. Then, the image converting unit 14 converts the live view images P1-P5 based on the number of detected cameras 2A-2E so that the live view images P1-P5 have equal image transparency. FIG. 4 shows a case where the live view images P1-P5 are converted to have the equal image transparency. However, as shown in FIG. 5, the live view images P1-P5 may be converted to have different colors or different densities.

In the normal imaging mode, when the images subjected to the image processing at the cameras 2A-2E are transmitted to the image converting unit 14, the image converting unit 14 combines the images to generate a composite image, and compresses the composite image according to a certain compression format, such as JPEG, and then writes the compressed image on the recording medium 24. When an instruction to playback the composite image is inputted, the image converting unit 14 reads out the compressed composite image from the recording medium 24 and decompresses the image. Then, the decompressed image is displayed on the display unit 4.

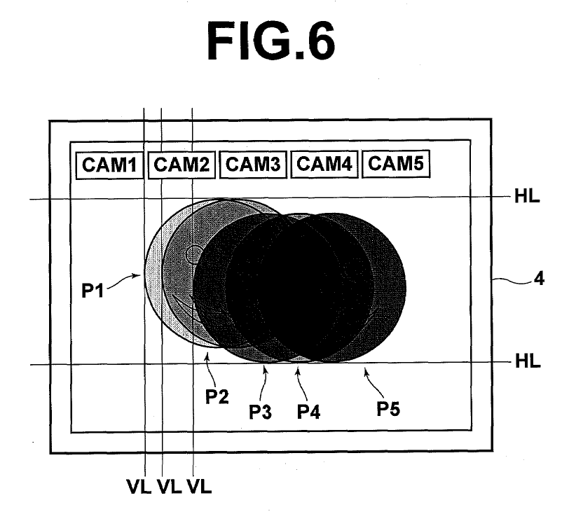

As shown in FIG. 6, the display controlling unit 16 displays the live view images P1-P5 converted by the image converting unit 14 on the display unit 4 in the superimposed manner, and also displays on the display unit 4 vertical guidelines VL which extend in the vertical direction of the display unit 4 and horizontal guidelines HL which extend in the horizontal direction of the display unit 4. In an initial state, the vertical guidelines VL and the horizontal guidelines HL are displayed at preset positions on the display unit 4, and the user can change the positions of the guidelines by manipulating the manipulation unit 12, such as the mouse and the keyboard. That is, when an instruction from the user to move any of the vertical guidelines VL and the horizontal guidelines HL is inputted, the display controlling unit 16 moves the corresponding vertical guideline VL or horizontal guideline HL according to the input via the inputting means. The display controlling unit 16 can display on the display unit 4 a single vertical guideline VL and a single horizontal guideline HL, or more than one vertical guidelines VL and more than one horizontal guidelines HL.

Further, the display controlling unit 16 has a function to display camera information CAM1-CAM5 for identifying the individual cameras 2A-2E on the display unit 4, in addition to the live view images P1-P5 displayed in the superimposed manner on the display unit 4. In a case where the live view images P1-P5 are displayed in different colors or different densities, the display controlling unit 16 may also display the camera information CAM1-CAM5 in the different colors or different densities correspondingly to the live view images P1-P5.

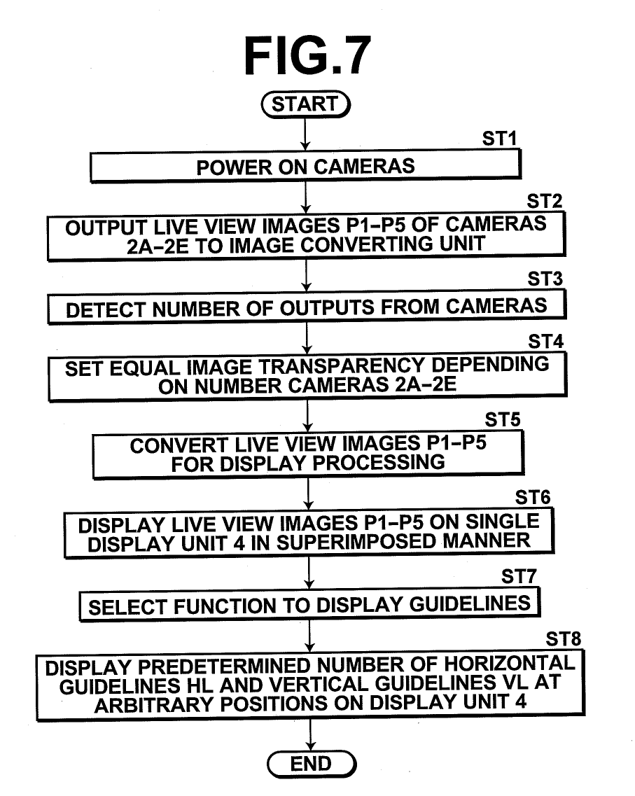

FIG. 7 is a flow chart illustrating a preferred embodiment of the method for displaying adjustment images in a multi-view imaging system of the invention. Now, the method for displaying adjustment images in the multi-view imaging system is described with reference to FIGS. 1 to 7. First, in a state where the system unit 3 is set in the adjustment mode by the user through the use of the manipulation unit 12, the cameras are powered on (step ST1), and imaging by the cameras 2A-2E is started. Then, images acquired by the image pickup devices 52 in the cameras 2A-2E are subjected to the image processing and the live view images P1-P5 are generated. The live view images P1-P5 are outputted to the image converting unit 14 in the system unit 3 (step ST2).

Then, the number of cameras connected to the system unit 3 is detected from the number of live view images P1-P5 inputted to the image converting unit 14 (step ST3). Then, image transparency values of the live view images P1-P5 are set depending on the number of detected cameras so that the live view images P1-P5 have equal image transparency (step ST4). The live view images P1-P5 are converted by the image converting unit 14 so that they have the set image transparency values (step ST5), and the converted live view images P1-P5 are displayed on the display unit 4 in the superimposed manner (step ST6). It should be noted that, in a case where the live view images P1-P5 are displayed in different colors or different densities, an operation to assign the different colors or different densities to the live view images P1-P5 is carried out. As the user selects the function to display the guidelines (step ST7), a predetermined number of the guidelines are displayed at predetermined positions on the display unit 4 (step ST8).

Displaying the live view images P1-P5 in the superimposed manner and also displaying the horizontal guidelines HL and the vertical guidelines VL on the display unit 4 in this manner allows the user to adjust the optical axes of the cameras 2A-2E by manipulating the manipulation unit 12 with viewing the display unit 4. That is, with the horizontal guidelines HL and the vertical guidelines VL being displayed, the user can set the guidelines HL and VL at positions where the subjects in the live view images P1-P5 should be placed on the display unit 4, and then, adjust the angles of view of the cameras so that the subjects in the respective images are placed along the guidelines HL and VL with viewing the display unit 4. In this manner, the user can efficiently and accurately adjust the angles of view of the cameras.

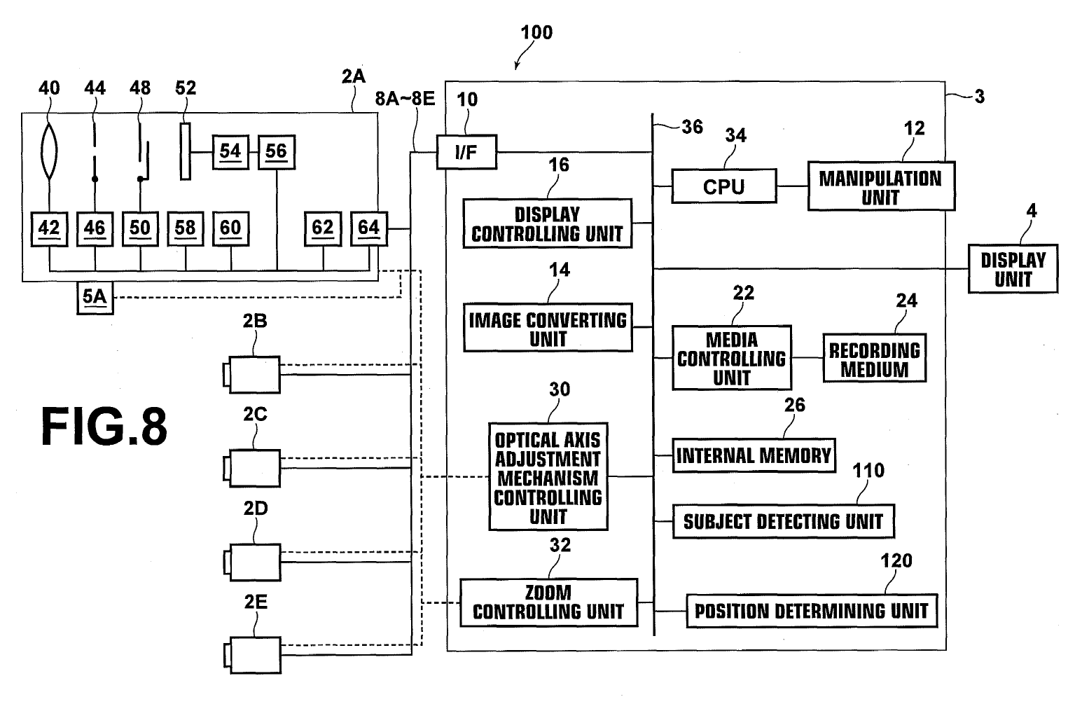

FIG. 8 is a block diagram illustrating a second embodiment of the multi-view imaging system of the invention. Now, a multi-view imaging system 100 is described with reference to FIG. 8. It should be noted that components shown in FIG. 8 which have the same configuration as the components of the multi-view imaging system 1 shown in FIG. 3 are designated by the same reference numerals and are not described in detail. A difference between the multi-view imaging system 100 shown in FIG. 8 and the multi-view imaging system 1 shown in FIG. 3 lies in that any of the cameras with an inappropriate angle of view is automatically identified and displayed.

Specifically, the multi-view imaging system 100 further includes a subject detecting unit 110 for detecting the subject from each of the live view images P1-P5, and a position determining unit 120 for determining, for each of the live view images P1-P5, whether or not the subject detected by the subject detecting unit 110 is positioned within an predetermined area on the display unit 4.

The subject detecting unit 110 detects the subject from each of the live view images P1-P5 using a known technique, such as AdaBoost algorithm based on edge detection or pattern matching. The position determining unit 120 calculates, for example, an average of positions of the subjects in the live view images P1-P5, and detects a distance from the average position to each subject in each of the live view images P1-P5. If the detected distance from the average position to the subject is equal to or larger than a set threshold, it is determined that the imaging optical axis of the camera among the cameras 2A-2E which has acquired the live view image with the distance from the average position equal to or larger than the threshold among the live view images P1-P5 is misaligned.

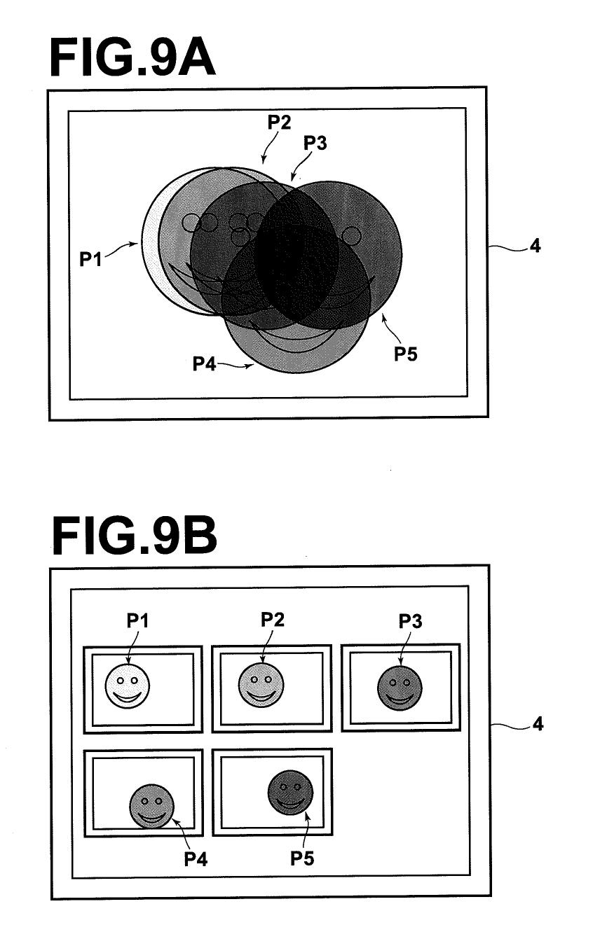

The display controlling unit 16 displays any of the live view images P1-P5 which has been determined at the position determining unit 120 that the subject contained therein is positioned out of the predetermined area, in a recognizable manner on the display unit 4. Specifically, assuming that the live view image P4 acquired by the camera 2D among the live view images P1-P5 is misaligned, as shown in FIG. 9A. Then, the display controlling unit 16 displays the live view image P4 with the positional misalignment in a recognizable manner. Specifically, the live view image P4 may be displayed in a warning color or may be blinked. In this example, the misaligned live view image P4 is, for example, blinked, however, in a case where the camera information is displayed on the display unit 4 (see FIG. 6), the camera information corresponding to the misaligned live view image may also be blinked.

The display controlling unit 16 may further include a function to display thumbnails of the live view images P1-P5, as shown in FIG. 9B, according to an instruction from the user inputted via the manipulation unit 12. This allows the user to easily check the imaging state of the cameras 2A-2E on a single screen.

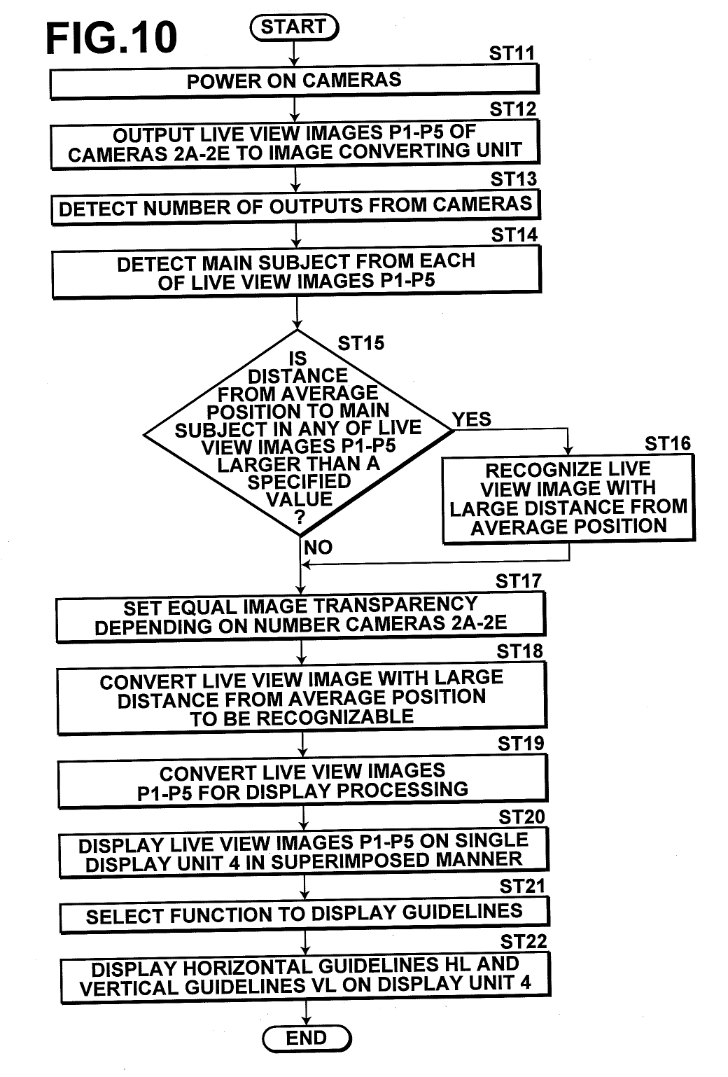

FIG. 10 is a flow chart illustrating an example of operations carried out in the multi-view imaging system 100 shown in FIG. 8. First, in a state where the system unit 3 is set in the adjustment mode by the user through the use of the manipulation unit 12, the cameras are powered on (step ST11), and imaging by the cameras 2A-2E is started. Then, images acquired by the image pickup devices 52 in the cameras 2A-2E are subjected to the image processing and the live view images P1-P5 are generated. The live view images P1-P5 are outputted to the image converting unit 14 in the system unit 3 (step ST12).

Then, the number of cameras connected to the system unit 3 is detected from the number of live view images P1-P5 inputted to the image converting unit 14 (step ST13). The subject detecting unit 110 detects the subject from each of the live view images P1-P5 (step ST14). Then, the position determining unit 120 determines, for each of the live view images P1-P5, whether or not the distance from the average position to the subject in each of the live view images P1-P5 is larger than a predetermined value (step ST15). If any of the live view images P1-P5 has the distance from the average position which is larger than the predetermined value, the live view image with the distance larger than the predetermined value is recognized (step ST16).

Thereafter, the image transparency values of the live view images P1-P5 are set depending on the number of detected cameras 2A-2E so that the live view images P1-P5 have equal image transparency (step ST17). The live view images P1-P5 are converted by the image converting unit 14 so that they have the set image transparency values, and if any of the live view images has the distance from the average position larger than the predetermined value, the live view image is converted to be recognizable on the display unit 4 and is displayed (steps ST18 and ST19). Then, the display controlling unit 16 displays the converted live view images P1-P5 in the superimposed manner on the display unit 4 (step ST20). As the user selects the function to display the guidelines (step ST21), a predetermined number of the guidelines are displayed at predetermined positions on the display unit 4 (step ST22). Automatically recognizing and displaying any of the cameras with a misaligned angle of view in this manner allows the user to recognize at a glance which of the cameras should be adjusted, and the user can efficiently adjust the angles of view of the cameras.

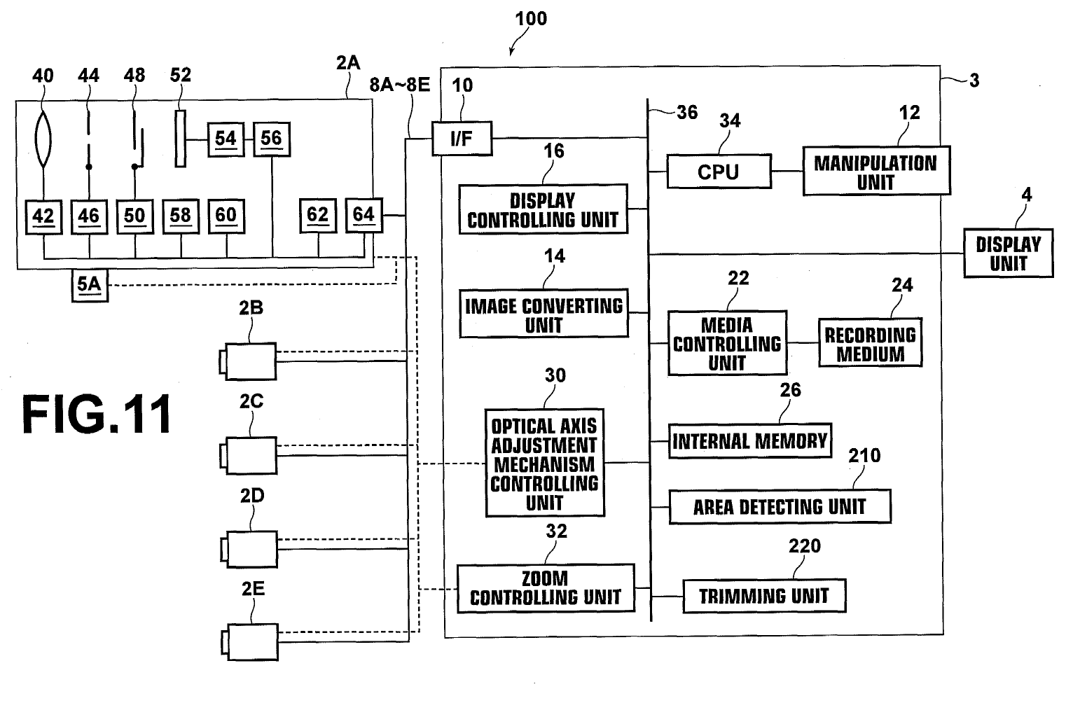

FIG. 11 is a block diagram illustrating a third embodiment of the multi-view imaging system of the invention. Now, a multi-view imaging system 200 is described with reference to FIG. 11. It should be noted that components shown in FIG. 11 which have the same configuration as the components of the multi-view imaging system 1 shown in FIG. 3 are designated by the same reference numerals and are not described in detail. A difference between the multi-view imaging system 200 shown in FIG. 11 and the multi-view imaging system 1 shown in FIG. 3 lies in that the live view images are automatically trimmed when they are combined.

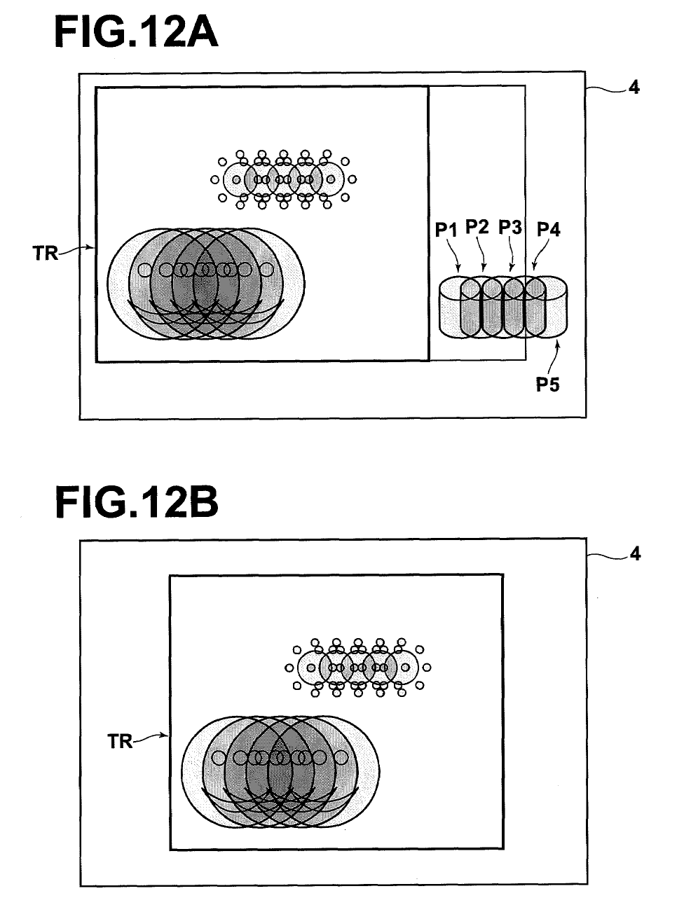

The multi-view imaging system 200 shown in FIG. 11 further includes an area detecting unit 210 and a trimming unit 220. The area detecting unit 210 detects a common imaging area which is contained in all the live view images P1-P5. For example, in the case of the live view images P1-P5 as shown in FIG. 12A, the area detecting unit 210 detects the subject in each image using an edge detection technique, for example, and then detects regions in the images containing the same subject as the common imaging area. The trimming unit 220 trims the live view images P1-P5 using the imaging area detected by the area detecting unit 210. Specifically, as shown in FIG. 12B, the imaging area detected by the area detecting unit 210 is set as a trimming frame TR to carry out the trimming.

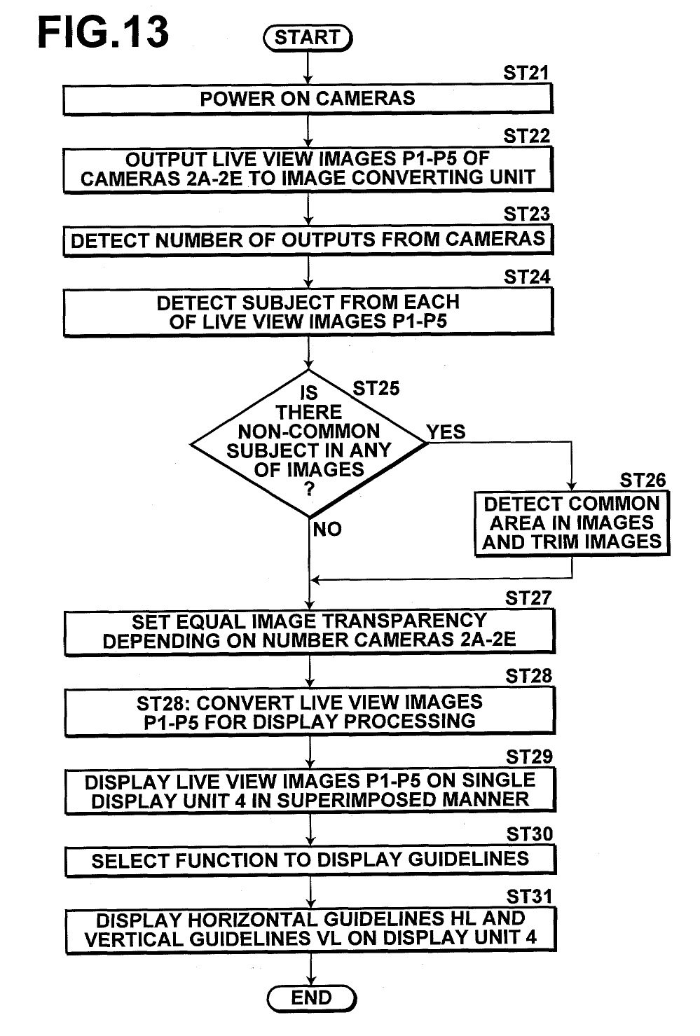

FIG. 13 is a flow chart illustrating an example of operations carried out in the multi-view imaging system 200 shown in FIG. 11. First, in a state where the system unit 3 is set in the adjustment mode by the user through the use of the manipulation unit 12, the cameras are powered on (step ST21), and imaging by the cameras 2A-2E is started. Then, images acquired by the image pickup devices 52 in the cameras 2A-2E are subjected to the image processing and the live view images P1-P5 are generated. The live view images P1-P5 are outputted to the image converting unit 14 in the system unit 3 (step ST22).

Then, the number of cameras connected to the system unit 3 is detected from the number of live view images P1-P5 inputted to the image converting unit 14 (step ST23). The area detecting unit 210 detects whether or not there is a common subject in the live view images P1-P5 (step ST24). If there is a non-common subject in any of the live view images P1-P5, the common imaging area of the images is detected and the images are trimmed according to the imaging area (steps ST25 and ST26).

Thereafter, the image transparency values of the live view images P1-P5 are set depending on the number of detected cameras so that the live view images P1-P5 have equal image transparency (step ST27). The trimmed live view images P1-P5 are converted by the image converting unit 14 so that they have the set image transparency values, and the display controlling unit 16 displays the converted live view images P1-P5 in the superimposed manner on the display unit 4 (steps ST28 and ST29). As the user selects the function to display the guidelines (step ST30), a predetermined number of the horizontal guidelines HL and the vertical guidelines VL are displayed at predetermined positions on the display unit 4 (step ST31).

By automatically trimming the images in this manner, unnecessary areas due to positional misalignment can automatically be deleted, and a region to be a common range of angle of view during imaging can efficiently be recognized.

According to the above-described embodiments, a subject is imaged with the more than one cameras 2A-2E to acquire more than one images, and the acquired images are subjected to the live view image processing to generate the live view images. The generated live view images P1-P5 are displayed in the superimposed manner on the display unit, and the vertical guidelines VL which extend in the vertical direction of the display unit 4 and the horizontal guidelines HL which extend in the horizontal direction of the display unit 4 are displayed on the display unit 4. This allows the user to see conditions of imaging by the individual cameras 2A-2E on a single screen and to recognize positional relationships between the vertical and horizontal guidelines VL and HL and the live view images P1-P5 in a moment in order to adjust the angles of view of the cameras 2A-2E. Therefore, the angles of view of the cameras 2A-2E can efficiently be adjusted.

In the case where the display controlling unit 16 displays the live view images P1-P5 having different colors or different densities in the superimposed manner, as shown in FIG. 5, the user can easily discriminate between the live view images P1-P5 displayed in the superimposed manner.

In the case where the display controlling unit 16 displays the camera information for identifying the individual cameras in different colors or different densities correspondingly to the live view images P1-P5 on the display unit, as shown in FIG. 6, the user can easily recognize which of the cameras 2A-2E is misaligned by what extent, and can more efficiently adjust the angles of view of the cameras 2A-2E.

In the case where the subject detecting unit 110 for detecting the subject in each of the live view images P1-P5, and the position determining unit 120 for determining, for each of the live view images P1-P5, whether or not the subject detected by the subject detecting unit 110 is positioned in a predetermined area on the display unit are provided, and the display controlling unit 16 recognizes and displays any of the live view images which has been determined by the position determining unit 120 that the subject contained therein is positioned out of the predetermined area, as shown in FIGS. 8-10, any of the cameras with a misaligned angle of view can automatically be recognized and displayed. Therefore, the angles of view of the cameras 2A-2E can efficiently be adjusted.

In the case where the area detecting unit 210 for detecting an imaging area contained in all the live view images P1-P5 and the trimming unit 220 for trimming the live view images P1-P5 using the imaging area detected by the area detecting unit 210 are provided, as shown in FIGS. 11-13, unnecessary areas due to positional misalignment can automatically be deleted and a region to be a common range of angle of view during imaging can efficiently be recognized.

The invention is not limited to the above-described embodiments. For example, although the image processing to generate the live view images P1-P5 is carried out by the image processing unit 62 provided in each of the cameras 2A-2E in the above-described embodiments, the image processing may be carried out by the image converting unit 14 provided in the system unit 3. In this case, the image information acquired by the cameras 2A-2E is transferred to the system unit 3, and the image converting unit 14 applies the live view image processing to the images.

Further, although the multi-view imaging apparatus 1 shown in FIG. 1 includes the cameras 2A-2E and the system unit 3, the system unit 3 may be built in the camera 2A, and the other cameras 2B-2E may be connected to the camera 2A.

Furthermore, although the image converting unit 14 converts the live view images P1-P5 so that they have equal image transparency, as shown in FIG. 4, the images may be converted such that the image acquired by the camera 2C, which is placed at the center of the cameras 2A-2E, has the highest image transparency and the image transparency may be gradually changed such that the images acquired by the outermost cameras have the lowest image transparency.

Moreover, when the user selects one of the live view images P1-P5, which is of interest, through the use of the manipulation unit 12, the image transparency of the selected live view image may be lowered.

According to the method for displaying adjustment images in a multi-view imaging system and the multi-view imaging system of the invention, a subject is imaged with a plurality of cameras to acquire a plurality of images, a plurality of live view images are generated by applying live view image processing to the acquired images; and the generated live view images are displayed in a superimposed manner on a display unit, and a vertical guideline extending in a vertical direction of the display unit and a horizontal guideline extending in a horizontal direction of the display unit are displayed at arbitrary positions on the display unit. This allows the user to see conditions of imaging by the cameras on a single screen and to recognize positional relationships between the vertical and horizontal guidelines and the live view images in a moment in order to adjust the angles of view of the cameras. Therefore, the angles of view of the cameras can be adjusted efficiently and accurately.

In the case where the display controlling unit displays the live view images having different colors or different densities in the superimposed manner, the user can easily discriminate between the live view images displayed in the superimposed manner.

In the case where the display controlling unit displays the camera information for identifying the individual cameras in different colors or different densities correspondingly to the live view images on the display unit, the user can easily recognize which of the cameras is misaligned by what extent, and can more efficiently adjust the angles of view of the cameras.

In the case where the subject detecting unit for detecting the subject in each of the live view images and the position determining unit for determining, for each of the live view images, whether or not the subject detected by the subject detecting unit is positioned in a predetermined area on the display unit are provided, and the display controlling unit displays any of the live view images which has been determined by the position determining unit that the subject contained therein is positioned out of the predetermined area, any of the cameras with a misaligned angle of view can automatically be recognized and displayed. Therefore, the angles of view of the cameras can efficiently be adjusted.

In the case where the area detecting unit for detecting an imaging area contained in all the live view images and the trimming unit for trimming the live view images using the imaging area detected by the area detecting unit are provided, unnecessary areas due to positional misalignment can automatically be deleted and a region to be a common range of angle of view during imaging can efficiently be recognized.

What is claimed is:

1. A method for displaying adjustment images in a multi-view imaging system, the method comprising:
imaging a subject with a plurality of cameras to acquire a plurality of images;
generating a plurality of live view images by applying live view image processing to the acquired images; and
displaying the generated live view images in a superimposed manner on a display unit and displaying, at arbitrary positions on the display unit, a vertical guideline extending in a vertical direction of the display unit and a horizontal guideline extending in a horizontal direction of the display unit.

2. A multi-view imaging system comprising:
a plurality of cameras to image a subject and acquire images;
an image processing unit to apply live view image processing to the images acquired by the cameras to generate a plurality of live view images; and
a display controlling unit to display the live view images generated by the image processing unit in a superimposed manner on a display unit and to display, at arbitrary positions on the display unit, a vertical guideline extending in a vertical direction of the display unit and a horizontal guideline extending in a horizontal direction of the display unit.

3. The multi-view imaging system as claimed in claim 2, wherein the display controlling unit displays the live view images having different colors or different densities in the superimposed manner.

4. The multi-view imaging system as claimed in claim 3, wherein the display controlling unit displays, on the display unit, camera information for identifying the individual cameras in different colors or different densities correspondingly to the live view images.

5. The multi-view imaging system as claimed in claim 2 further comprising:
a subject detecting unit to detect the subject from each of the live view images; and
a position determining unit to determine, for each of the live view images, whether or not the subject detected by the subject detecting unit is positioned in a predetermined area on the display unit,
wherein, if the position determining unit has determined that any of the live view images contains the subject positioned out of the predetermined area, the display controlling unit displays the determined live view image in a recognizable manner.

6. The multi-view imaging system as claimed in claim 2 further comprising:
an area detecting unit to detect an imaging area contained in all the live view images; and
a trimming unit to trim the live view images using the imaging area detected by the area detecting unit.

7. The multi-view imaging system as claimed in claim 2, wherein the display controlling unit comprises a function to display thumbnails of the live view images.
